(19) United States
(12) Patent Application Publication
(10) Pub. No.: US 2015/0324728 A1
(43) Pub. Date: Nov. 12, 2015

(54) DYNAMIC TASK DISTRIBUTION SYSTEM

(71) Applicant: Oracle International Corporation, Redwood Shores, CA (US)

(72) Inventors: Niladri DE, Hyderabad (IN); Srinivasu DUDALA, Hyderabad (IN); Mani Kumar Vran KASIBHATLA, Hyderabad (IN)

(73) Assignee: Oracle International Corporation, Redwood Shores, CA (US)

(21) Appl. No.: 14/273,646

(22) Filed: May 9, 2014

(51) Int. Cl. G06Q 10/06

(52) U.S. Cl. CPC G06Q 10/063114

(57) ABSTRACT

A system is provided that that dynamically distributes tasks. The system calculates scores for tasks, where each score is calculated based on a finish-by date-time for each task, a planned finish date-time for each task, a planned effort for each task, and a base priority for each task. The system further determines an order that the tasks are executed based on the scores. The system further displays the tasks and a project plan timeline within a user interface, where the tasks are displayed within the project plan timeline based on the order that the plurality of tasks are executed. The system further determines a buffer time distribution for the tasks based on the scores. The system further displays the tasks within the project plan timeline based on the buffer time distribution for the tasks.

### FIELD

One embodiment is directed to a computer system, and more particularly, to a computer system that displays data.

### BACKGROUND

Project managers or planners typically work with a project plan timeline, which is a set of tasks that are associated with an overall project or objective, and that are displayed over a timeline. Project managers typically define the project plan timeline, and thus, typically define how tasks are distributed within the project plan timeline. During most projects, delays typically occur, where an execution of a task occurs later than originally planned. Depending on the distribution of the tasks within the project plan timeline, a delay of a task can have a minor impact, or a major impact, on the progress of the overall project. However, in the industry today, task scheduling is typically done “optimistically,” meaning it is assumed that tasks will not be delayed. Because of this, impacts to the progress over the overall project caused by delays of tasks are typically overlooked in a planning stage of a project plan timeline.

### SUMMARY

One embodiment is a system that dynamically distributes tasks. The system calculates scores for tasks, where each score is calculated based on a finish-by date-time for each task, a planned finish date-time for each task, a planned effort for each task, and a base priority for each task. The system further determines an order that the tasks are executed based on the scores. The system further displays the tasks and a project plan timeline within a user interface; where the plurality of tasks are displayed within the project plan timeline based on the order that the plurality of tasks are executed.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates a task ordering for a set of tasks, according to an embodiment of the invention.

FIG. 3 illustrates a buffer time distribution for a sequential chain of tasks, according to an embodiment of the invention.

FIG. 4 illustrates a flow diagram of the functionality of a dynamic task distribution module, according to an embodiment of the invention.

FIG. 5 illustrates a flow diagram of the functionality of a dynamic task distribution module, according to another embodiment of the invention.

### DETAILED DESCRIPTION

According to an embodiment, a dynamic task distribution system is provided. The dynamic task distribution system can provide a formula used to calculate a score for each task within a set of tasks. The formula can be based on one or more of the following: a “finish-by date-time” for each task, a “planned finish date-time” for each task, a “planned effort” for each task, or a “base priority” for each task, where a “date-time” is a specific date and/or time. The formula can be system-defined, where the formula can optionally be further customized by a user of the dynamic task distribution system. Alternately, the formula can be user-defined. The dynamic task distribution system can subsequently determine an order of execution for the tasks based on the calculated scores. The dynamic task distribution system can further determine a buffer time distribution among the tasks based on the calculated scores. Further, the dynamic task distribution system can display a project plan timeline within a user interface, where the tasks can be displayed within the project plan timeline based on the determined order of execution or the determined buffer distribution. Thus, in other words, the dynamic task distribution system can dynamically distribute tasks within the displayed project plan timeline based on the calculated scores.

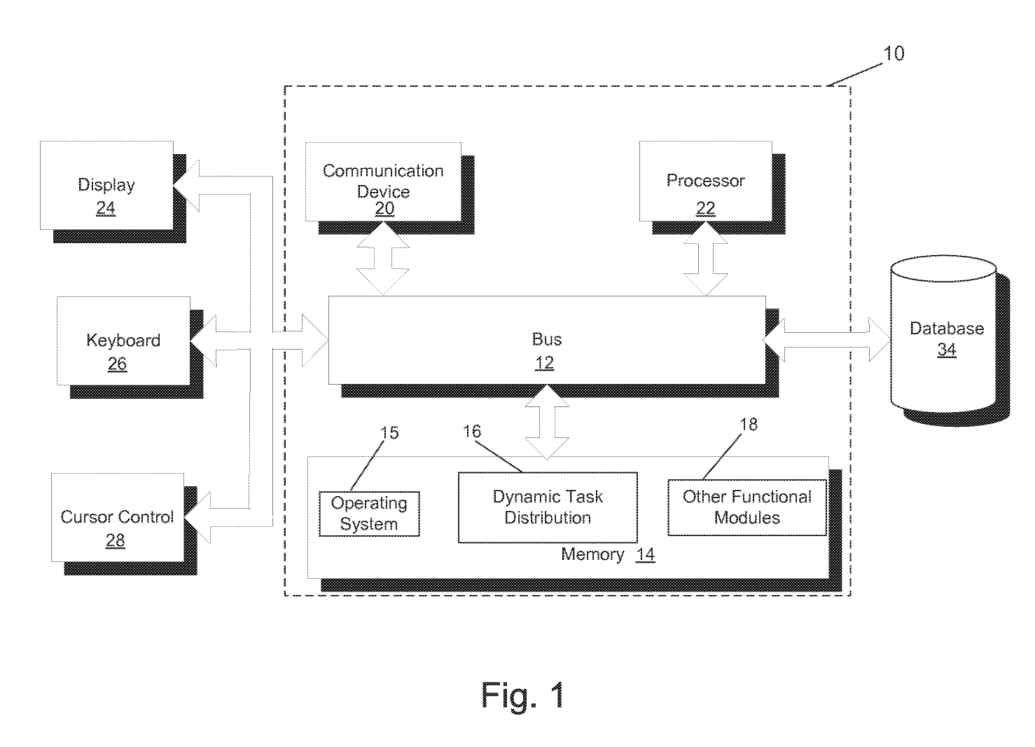

FIG. 1 illustrates a block diagram of a system 10 that can implement one embodiment of the invention. System 10 includes a bus 12 or other communications mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communications interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, a dynamic task distribution module 16, as well as other functional modules 18. Operating system 15 can provide an operating system functionality for system 10. Dynamic task distribution module 16 can provide functionality for dynamically determining a task execution order and/or a buffer time distribution for one or more tasks, as further disclosed below. In certain embodiments, dynamic task distribution module 16 can comprise a plurality of modules, where each module provides specific individual functionality for dynamically determining a task execution order and/or a buffer time distribution for one or more tasks. System 10 can also be part of a larger system. Thus, system 10 can include one or more additional functional modules 18 to include the additional functionality. For example, functional modules 18 may include modules that provide additional functionality, such as functionality of a “Primavera Enterprise Project Portfolio Management” by Oracle Corporation.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

There are certain considerations in determining a distribution of tasks within a project plan timeline in the project execution industry. The first consideration is determining an optimal order of task execution for a set of tasks, given that multiple tasks can be executed in any sequence, or order. There can be many criteria in determining an optimal order of task execution for a set of tasks. For example, if a task, or a remaining portion of a task, has a higher effort or duration, then it makes sense to finish the task earlier, such that the chance of recovery is higher in case of any delay, or other unforeseen problems. Further, if a task has a higher base priority or importance, then it also makes sense to finish the task earlier, such that the chance of recovery is higher in case of any delay, or other unforeseen problems. Additionally, if a task is needed to be finished at an earlier date (i.e., the task has an earlier finish-by constraint), then it also makes sense to finish the task earlier, such that the chance of recovery is higher in case of any delay, or other unforeseen problems. As can be seen, the three aforementioned criteria are in competition with each other, and a formulation is needed to determine the most optimal order of execution for a set of tasks.

The second consideration is determining an optimal distribution of buffer time among a set of tasks, given that an order of execution for the multiple tasks has been time, and given that an amount of buffer time is available. A buffer time for a task is an amount of “float” time for task. In other words, a buffer time for a task is an amount of time between a planned finish date-time for a task (i.e., a date-time that the task is planned to finish by) and a finish-by date-time for the task (i.e., a date-time that the task is required to be finished by). A buffer time for a project plan is a total amount of “float” time for the project plan, and the buffer time for the project plan can be distributed among the tasks of the project plan. In a similar fashion, if there is a sequential chain of tasks, and the sequential chain of tasks has a total amount of “float” time or buffer time, the buffer time can also be distributed among the sequence of tasks. There can be many criteria in determining an optimal distribution of buffer time among a set of tasks. For example, if a task, or a remaining portion of a task, has a higher effort or duration, it makes sense to allocate more buffer time to the task, such that the chance of recovery is higher in case of any delay, or other unforeseen problems. Further, if a task has a higher base priority or importance, it also makes sense to allocate more buffer time to the task, such that the chance of recovery is higher in case of any delay, or other unforeseen problems. Additionally, if a task is needed to be finished at an earlier date-time (i.e., the task has an earlier finish-by date-time constraint), then it also makes sense to allocate more buffer time to the task, such that the chance of recovery is higher in case of any delay, or other unforeseen problems. Similar to the consideration of order of execution, the three aforementioned criteria are in competition with each other, and a formulation is needed to determine the most optimal distribution of buffer time among a set of tasks.

As one can also see, the aforementioned considerations are considerations of potential problems (i.e., problems, such as task delays, that have not yet happened, but might happen in the future). In the industry today, as previously described, task scheduling is typically done “optimistically,” meaning it is assumed that nothing will go wrong. As a result, potential problems, such as task delays, are generally overlooked in a project planning stage. However, task delays can occur, and can result in unacceptable slippages of the project plan.

Thus, while a dynamic task distribution system that determines both an optimal order of execution for a set of tasks and an optimal buffer time distribution among the set of tasks may not prevent task delays, but the dynamic task distribution system can significantly increase a probability that a recovery from a task delay can be made in such a manner that the overall project plan timeline is not delayed, and in case of any delay, major reorganization of the project plan (i.e., task dates and assignments) is not needed. In other words, the determination of the optimal order of execution and the optimal buffer distribution can provide for an optimal distribution of tasks within a project plan timeline so that the project plan timeline and organization are highly resistant to task delays.

According to an embodiment, as previously described, a dynamic task distribution system can provide a methodology or formula used to calculate a score for each task within a set of tasks. An example formula is provided below, according to an example embodiment:

$\frac{1}{\frac{{D}_{FB} - {D}_{PF}}{E \times P} + 0.01}$

| Symbol | Meaning |
|---|---|
| D_{FB} | Date-time of the Finish-By constraint for a task. If the task does |
| | not have a Finish-by constraint, then finish date-time of a task |
| | group that the task belongs to should apply. |
| D_{PF} | Date-time of the Planned Finish for a task |
| | In case of task ordering calculation, if the task is not already |
| | in progress, then planned finish date-time is calculated |
| | assuming the task is started right now (current date-time = |
| | start date-time), and then by adding planned duration of the |
| | task |
| | In case of buffer time distribution calculation, planned finish |
| | date-time is calculated by placing all tasks at their earliest |
| | possible start date-times (after observing a specified |
| | sequence), and then by adding planned duration of the task |
| E | Total estimated/planned effort for a task (or a remaining |
| | incomplete portion of the task). Effort = duration x allocation. If |
| | allocation is 100%, then duration is equal to effort. However, for |
| | example, if allocation is 50%, then duration is twice that of effort. |
| P | Base priority (or importance) of a task. This can be a numerical |
| | value between 1 and 10, both inclusive. 1 can indicate a lowest |
| | priority, while 10 can indicate a highest priority. Can also be a |
| | decimal, rather than an integer, such as 9.63. |

According to the embodiment, based on the example formula provided above, the closer a finish-by date-time for a task is to a current date-time, the higher the calculated score for the task is. Further, the higher the planned (or remaining) effort for the task is, the higher the calculated score for the task is. Even further, the higher the base priority (or importance) for the task is, the higher the calculated score for the task is. In other words, a calculated score for a task is: (a) inversely correlated to a difference between a finish-by date-time for the task and a current date-time; (b) directly correlated to a planned (or remaining) effort for the task; and (c) directly correlated to a base priority (or importance) for the task.

According to the embodiment, if a task has to be started right now (i.e., at a current date-time), in order to meet a finish-by date-time for the task, the term (D_{FB}−D_{PF}) of the formula becomes 0, and the score for the task is calculated to be a maximum value, such as 100. In other words, any task which has to be started right now (i.e., at a current date-time) is automatically set to a maximum value, such as 100.

Further, according to the embodiment, a calculated score for a task can be a value that is a dimensionless number. This is because a unit (i.e., dimension) of date-time difference (i.e., duration) is the same as the unit (i.e. dimension) of effort. In one embodiment, this unit (i.e., dimension) can be measured in days. Additionally, in one embodiment, a date-time difference (i.e., duration) can be measured in working time, rather than calendar time, where weekend days are not taken into consideration when calculating a date-time difference (i.e., duration).

In other alternate embodiments, a dynamic task distribution system can provide other alternate formulas used to calculate a score for each task within a set of tasks. This is because a single formula may not be suitable for everyone, and the formula may need to be tailored based on a domain, an industry, or a specific business case. Further, in certain embodiments, a formula provided by the dynamic task distribution system can be further customized by a user of the dynamic task distribution system. In other alternate embodiments, the formula can be provided by the user, rather than by the dynamic task distribution system. Other example alternate formulas are provided below, according to example embodiments:

$$\frac{2}{\frac{( {( {D}_{FB} )}^{3} - {( {D}_{PF} )}^{3} )}{E \times P} + 0.5}$$

$$\frac{5}{4 \times {( \frac{{D}_{FB} - {D}_{PF}}{E \times P} )}^{2} + 0.3}$$

However, one of ordinary skill in the art would readily appreciate that the aforementioned formulas are merely example formulas, and that the formulas that can be provided by the dynamic task distribution system are not limited to the aforementioned formulas. Thus, in other alternate embodiments, the dynamic task distribution system can provide other alternate formulas used to calculate a score for each task within a set of tasks.

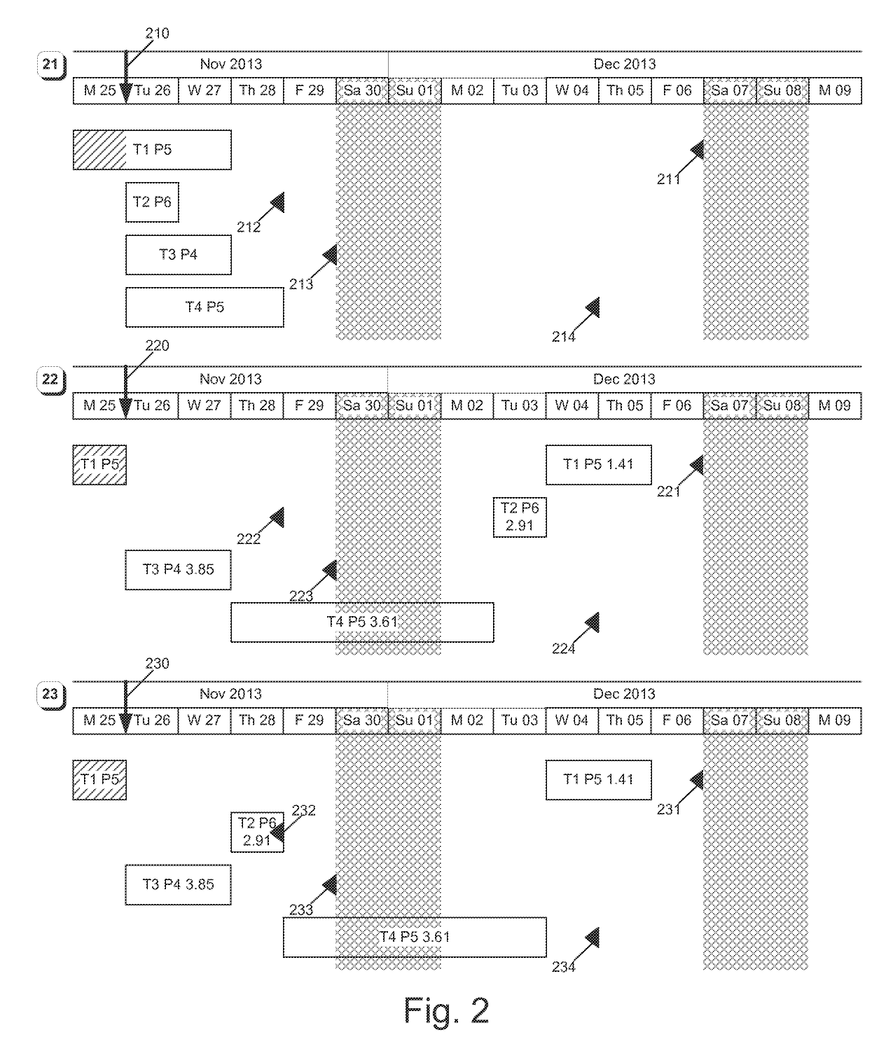

According to an embodiment, once the dynamic task distribution system has calculated a score for each task of the tasks, the dynamic task distribution system can subsequently determine an order of execution for the tasks based on the calculated scores. Once the dynamic task distribution system has determined the order of execution, the dynamic task distribution system can further display the tasks within a project plan timeline based on the determined order of execution for the tasks, and display the project plan timeline and the tasks within a user interface. An example of a dynamic task distribution system determining an order of execution for a set of tasks based on calculated scores for the tasks is now described in greater detail in conjunction with FIG. 2.

FIG. 2 illustrates a task ordering for a set of tasks, according to an embodiment of the invention. More specifically, FIG. 2 illustrates a project plan 21 displayed by a dynamic task distribution system, such as system 10 of FIG. 1. Arrow 210 indicates a current date-time of Nov. 26, 2013 (start-of-day). Project plan 21 includes tasks T1, T2, T3, and T4, which are displayed within a timeline, where tasks T1, T2, T3, and T4 are assigned to a resource. Tasks T1, T2, T3, and T4 each have different efforts, different finish-by date-times and different priorities. More specifically, task T1 has a remaining effort of 2 days, since a portion of task T1 with an effort of 1 day was already completed on Nov. 25, 2013, indicated by the hatched portion of task T1. Task T1 also has a priority of 5, and has a finish-by date-time of Dec. 6, 2013 (end-of-day), indicated by arrow 211. Task T2 has a planned effort of 1 day. Task T2 also has a priority of 6, and a finish-by date-time of Nov. 28, 2013 (end-of-day), indicated by arrow 212. Task T3 has a planned effort of 2 days. Task T3 also has a priority of 4, and a finish-by date-time of Nov. 29, 2013 (end-of-day), indicated by arrow 213. Task T4 has a planned effort of 3 days. Task T4 also has a priority of 5, and a finish-by date-time of Dec. 4, 2013 (end-of-day), indicated by arrow 214.

According to the embodiment, the dynamic task distribution system can automatically determine an order of tasks T1, T2, T3, and T4. First, as illustrated in project plan 21 of FIG. 2, the dynamic task distribution system displays all the tasks (or the remaining portions of the tasks) so that they are aligned to start at the current date-time (i.e., Nov. 26, 2013 (start-of-day)). In other words, the dynamic task distribution system aligns a display of the remaining portion of task T1, and a display of tasks T2, T3, and T4, to start at arrow 210. In alternate embodiments, the dynamic task distribution system can align a display of the remaining portion of task T1, and a display of tasks T2, T3, and T4, to start at any other position within the project plan timeline. Thus, based on the fact that all the tasks (or the remaining portions of the tasks) start at the current date-time: a planned finish date-time for task T1 is Nov. 27, 2013 (end-of-day); a planned finish date-time for task T2 is Nov. 26, 2013 (end-of-day); a planned finish date-time for task T3 is Nov. 27, 2013 (end-of-day); and a planned finish date-time for task T4 is Nov. 28, 2013 (end-of-day).

Subsequently, the dynamic task distribution system calculates a score for tasks T1, T2, T3, and T4, as shown below in the following table:

| | Remain- | | | | |
|---|---|---|---|---|---|
| Task | ing | Finish-by | Base | | |
| Name | Effort | Date-Time | Priority | Formula | Score |
| T1 | 2 | End of Day (“EOD”) Dec. 5, 2013 | 5 | $\frac{1}{\frac{( 29 - 27 + 6 - 1 )}{2 \times 5} + 0.01}$ | 1.41 |
| T2 | 1 | EOD Nov. 28, 2013 | 6 | $\frac{1}{\frac{( 28 - 26 )}{1 \times 6} + 0.01}$ | 2.91 |
| T3 | 2 | EOD Nov. 29, 2013 | 4 | $\frac{1}{\frac{( 29 - 27 )}{2 \times 4} + 0.01}$ | 3.85 |
| T4 | 3 | EOD Dec. 4, 2013 | 5 | $\frac{1}{\frac{( 29 - 28 + 4 - 1 )}{3 \times 5} + 0.01}$ | 3.61 |

Thus, the dynamic task distribution system calculates a score of 1.41 for task T1, calculates a score of 2.91 for task T2, calculates a score of 3.85 for task T3, and calculates a score of 3.61 for task T4. Based on the calculated scores (i.e., a decreasing order of score value), the dynamic task distribution system determines an order of execution for tasks T1, T2, T3, and T4 to be: (1) task T3 (score: 3.85); (2) task T4 (score: 3.61); (3) task T2 (score: 2.91) and (4) task T1 (score: 1.41).

FIG. 2 further illustrates a project plan 22 displayed by a dynamic task distribution system. Arrow 220 indicates a current date-time of Nov. 26, 2013 (start-of-day). Project plan 22 includes tasks T1, T2, T3, and T4, which are displayed within a timeline. Task T1 has a finish-by date-time of Dec. 6, 2013 (end-of-day), indicated by arrow 221. Task T2 has a finish-by date-time of Nov. 28, 2013 (end-of-day), indicated by arrow 222. Task T3 has a finish-by date-time of Nov. 29, 2013 (end-of-day), indicated by arrow 223. Task T4 has a finish-by date-time of Dec. 4, 2013 (end-of-day), indicated by arrow 224.

According to the embodiment, tasks T1, T2, T3, and T4 are displayed according to the order of execution previously determined by the dynamic task distribution system. More specifically, a remaining portion of task T1 is split from a completed portion of T1, indicated by the hatched portion of task T1. Further, task T3 is displayed with a start date-time of Nov. 26, 2013 (start-of-day), task T4 is displayed with a start date-time of Nov. 28, 2013 (start-of-day), task T2 is displayed with a start date-time of Dec. 3, 2013 (start-of-day), and the remaining portion of task T1 is displayed with a start date-time of Dec. 4, 2013 (start-of-day).

According to the embodiment, the dynamic task distribution system analyzes the placement of tasks T1, T2, T3, and T4, and identifies that task T2 violates its finish-by date-time, because task T2 starts on Dec. 3, 2013 (start-of-day), which is after the finish-by date-time for task T2 (i.e., Nov. 28, 2013 (end-of-day)). Thus, the dynamic task distribution system can determine that the determined order of execution for tasks T1, T2, T3, and T4 is not an acceptable order of execution. To prevent the violation, the dynamic task distribution system can swap a position of task T2 with a position of an alternate task that is an “eligible task”. An “eligible task” is an alternate task that meets a pre-defined criteria. In one embodiment, the alternate task can be required to meet the following pre-defined criteria in order to be an eligible task: (a) by swapping a position of the original task with a position of the alternate task, the original task does not violate its finish-by date-time constraint; (b) the alternate task has the lowest score of the alternate tasks that meet criteria (a); and (c) the alternate task does not violate its own finish-by date-time after its position is pushed back by a duration of the original task. Thus, in the illustrated embodiment, the position of task T2 is swapped with the position of task T4, since task T4 has the lowest score of all the tasks that meet criteria (a) and criteria (c) (i.e., tasks T3 and T4).

FIG. 2 further illustrates a project plan 23 displayed by a dynamic task distribution system. Arrow 230 indicates a current date-time of Nov. 26, 2013 (start-of-day). Project plan 23 includes tasks T1, T2, T3, and T4, which are displayed within a timeline. Task T1 has a finish-by date-time of Dec. 6, 2013 (end-of-day), indicated by arrow 231. Task T2 has a finish-by date-time of Nov. 28, 2013 (end-of-day), indicated by arrow 232. Task T3 has a finish-by date-time of Nov. 29, 2013 (end-of-day), indicated by arrow 233. Task T4 has a finish-by date-time of Dec. 4, 2013 (end-of-day), indicated by arrow 234.

According to the embodiment, project plan 23 is identical to project plan 22, except the dynamic task distribution system has swapped a position of T2 with a position of T4. Thus, the order of execution for tasks T1, T2, T3, and T4 is now: (1) task T3; (2) task T2; (3) task T4; and (4) task T1. Therefore, according to the embodiment, tasks T1, T2, T3, and T4 can be completed without violating a finish-by date-time constraint of any task, and all tasks can be finished by their respective finish-by date-times.

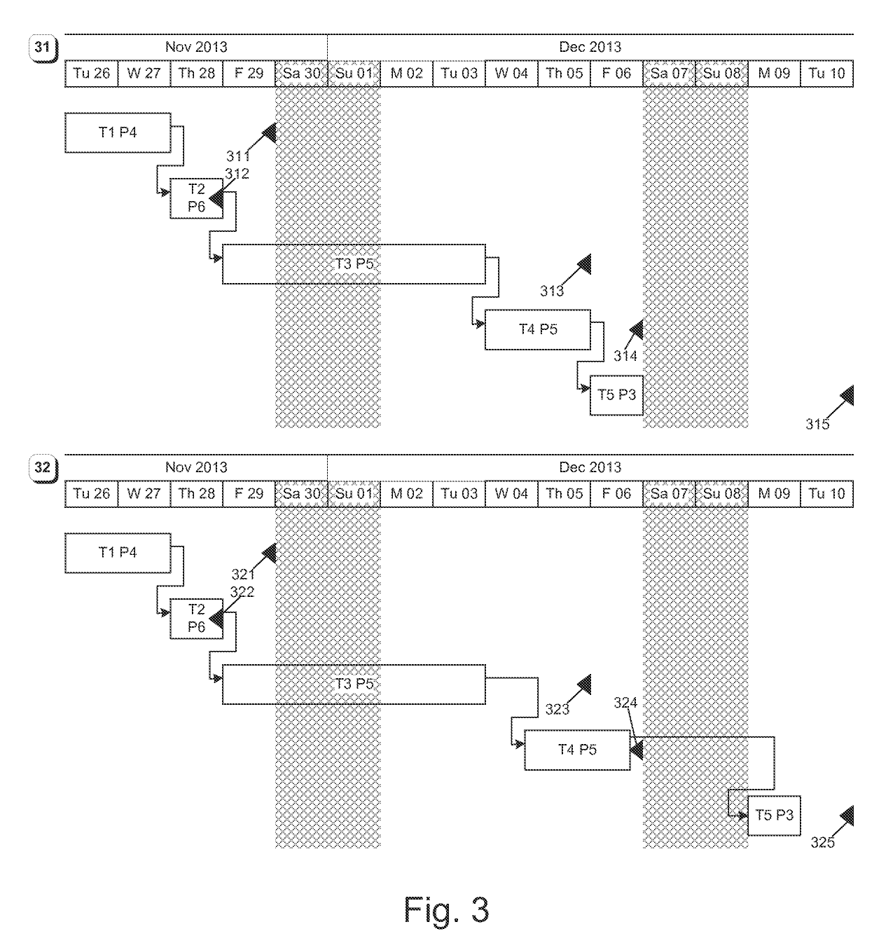

According to an embodiment, once the dynamic task distribution system has calculated a score for each task of the tasks, and has determined an order of execution for the tasks based on the calculated scores, the dynamic task distribution system can further determine a buffer time distribution for the tasks based on the calculated scores. As previously described, a buffer time for a task is an amount of time between a planned finish date-time for a task and a finish-by date-time for the task. A buffer time for a project plan is a total amount of time left if all the tasks of the project plan are completed at their earliest possible opportunity. Similarly, a buffer time for a sequential chain of tasks is a total amount of time left if all the tasks of the sequential chain of tasks are executed at their earliest opportunities, while following their pre-defined order of execution. Thus, the dynamic task distribution system can distribute buffer time for a sequential chain of tasks among the tasks based on any proportion. For example, for a sequential chain of tasks that includes a set of four tasks, 50% of the buffer time for the sequential chain of tasks can be distributed to the first task, 20% of the buffer time for the sequential chain of tasks can be distributed to the second task, 20% of the buffer time for the sequential chain of tasks can be distributed to the third task, and 10% of the buffer time for the sequential chain of tasks can be distributed to the fourth task. Once the dynamic task distribution system has determined the buffer time distribution, the dynamic task distribution system can further display the tasks within a project plan timeline based on the determined buffer time distribution, and display the project plan timeline and the tasks within a user interface. An example of a dynamic task distribution system determining a buffer time distribution for a set of tasks based on calculated scores for the tasks is now described in greater detail in conjunction with FIG. 3.

FIG. 3 illustrates a buffer time distribution for a sequential chain of tasks, according to an embodiment of the invention. More specifically, FIG. 3 illustrates a project plan 31 displayed by a dynamic task distribution system. Project plan 31 includes tasks T1, T2, T3, T4, and T5, which are displayed within a timeline, where tasks T1, T2, T3, T4, and T5 have a sequential chain of finish-to-start dependency between each other. More specifically, task T2 has a finish-to-start dependency (“FSD”) on task T1, meaning that task T2 cannot be started unless task T1 is completed. Similarly, tasks T3, T4, and T5 have an FSD on tasks T2, T3, and T4, respectively. Tasks T1, T2, T3, T4, and T5 each have different efforts, different finish-by date-times and different priorities. More specifically, task T1 has a planned effort of 2 days. Task T1 also has a priority of 4, and has a finish-by date-time of Nov. 29, 2013 (end-of-day), indicated by arrow 311. Task T2 has a planned effort of 1 day. Task T2 also has a priority of 6, and a finish-by date-time of Nov. 28, 2013 (end-of-day), indicated by arrow 312. Task T3 has a planned effort of 3 days. Task T3 also has a priority of 5, and a finish-by date-time of Dec. 5, 2013 (end-of-day), indicated by arrow 313. Task T4 has a planned effort of 2 days. Task T4 also has a priority of 5, and a finish-by date-time of Dec. 6, 2013 (end-of-day), indicated by arrow 314. Task T5 has a planned effort of 1 day. Task T5 also has a priority of 3, and a finish-by date-time of Dec. 10, 2013 (end-of-day), indicated by arrow 315.

According to an embodiment, the dynamic task distribution system has determined an order of execution to be: (1) task T1; (2) task T2; (3) task T3; (4) task T4; and (5) task T5. Further, the dynamic task distribution system has scheduled task T1 to start at the earliest possible date-time (i.e., Nov. 26, 2013 (start-of-day)), and has scheduled each successor task to begin immediately after a predecessor task's planned finish date-time. Thus, task T1 has a planned start date-time of Nov. 26, 2013 (start-of-day) and a planned finish date-time of Nov. 27, 2013 (end-of-day). Task T2 has a planned start date-time of Nov. 28, 2013 (start-of-day) and a planned finish date-time of Nov. 28, 2013 (end-of-day). Task T3 has a planned start date-time of Nov. 29, 2013 (start-of-day) and a planned finish date-time of Dec. 3, 2013 (end-of-day). Task T4 has a planned start date-time of Dec. 4, 2013 (start-of-day) and a planned finish date-time of Dec. 4, 2013 (end-of-day). Task T5 has a planned start date-time of Dec. 6, 2013 (start-of-day) and a planned finish date-time of Dec. 6, 2013 (end-of-day).

According to the embodiment, a buffer time for project plan 31 exists, where the buffer time is 2 days. The dynamic task distribution system initially distributes the buffer time at the end of project plan 31 (i.e., distributes the buffer time to the last task of the project plan, task T5). Thus, task T1 initially does not have a buffer time (illustrated in project plan 31 of FIG. 3 by showing a right edge or finish date-time edge of task T1 as collinear with a left edge or start date-time edge of task T2), task T2 initially does not have a buffer time (illustrated in project plan 31 of FIG. 3 by showing a right edge or finish date-time edge of task T2 as collinear with a left edge or start date-time edge of task T3), task T3 initially does not have a buffer time (illustrated in project plan 31 of FIG. 3 by showing a right edge or finish date-time edge of task T3 as collinear with a left edge or start date-time of task T4), and task T4 initially does not have a buffer time (illustrated in project plan 31 of FIG. 3 by showing a right edge or finish date-time edge of task T4 as collinear with a left edge or start date-time of task T5). Further, task T5 initially has a buffer time of 2 days (i.e., Dec. 9 and 10, 2013). The buffer time for task T5 is applied after the planned finish date-time of task T5.

Subsequently, the dynamic task distribution system calculates a score for tasks T1, T2, T3, T4, and T5, as shown below in the following table:

| Task | Remaining | Finish-by | Base | | |
|---|---|---|---|---|---|
| Name | Effort | Date-Time | Priority | Formula | Score |
| T1 | 2 | End of Day (“EOD”) Nov. 29, 2013 | 4 | $\frac{1}{\frac{( 29 - 27 )}{2 \times 4} + 0.01}$ | 3.85 |
| T2 | 1 | EOD Nov. 28, 2013 | 6 | $\frac{1}{\frac{( 28 - 28 )}{1 \times 6} + 0.01}$ | 100.00 |
| T3 | 3 | EOD Dec. 5, 2013 | 5 | $\frac{1}{\frac{( 5 - 3 )}{3 \times 5} + 0.01}$ | 6.98 |
| T4 | 2 | EOD Dec. 6, 2013 | 5 | $\frac{1}{\frac{( 6 - 5 )}{2 \times 5} + 0.01}$ | 9.09 |
| T5 | 1 | EOD Dec. 10, 2013 | 3 | $\frac{1}{\frac{( 10 - 8 )}{1 \times 3} + 0.01}$ | 1.48 |

Thus, the dynamic task distribution system calculates a score of 3.85 for task T1, calculates a score of 100.00 for task T2, calculates a score of 6.98 for task T3, calculates a score of 9.09 for task T4, and calculates a score of 1.48 for task T5. These scores for tasks T1, T2, T3, T4, and T5 are identified as “self scores” or “Sₛ”. Subsequently, the dynamic task distribution system calculates a “self forward total score” or “S_{SFT}” for each task of tasks T1, T2, T3, T4, and T5. A self forward total score is calculated by adding a self score for a task with all self scores for all forward (i.e., downstream) tasks. For example, a self forward total score for task T1 is 121.40 (i.e., 3.85+100.00+6.98+9.09+1.48).

The dynamic task distribution system further calculates a buffer time available value for each task of tasks T1, T2, T3, T4, and T5. The buffer time available value is also identified as a “buffer self available initial value” or “B_{SI}”. The buffer self available initial value for a task is the buffer time available between a planned finish date-time of a task and a finish-by date-time of a task. For example, a buffer self available initial value for task T1 is 2 days (i.e., Nov. 29, 2013-Nov. 27, 2013). Subsequently, for each task of tasks T1, T2, T3, T4, and T5, the dynamic task distribution system calculates a minimum buffer available downstream value (i.e., a minimum value of all the downstream buffer self available initial values), excluding the buffer self available initial value of the present task. The minimum buffer available downstream value is also identified as a “buffer forward minimum value” or “B_{FM}”. For example, a buffer forward minimum value for task T1 is 0 (i.e., a minimum of 0, 2, 1, and 2).

The dynamic task distribution system further calculates an apportioned buffer forward minimum value for each task of tasks T1, T2, T3, T4, and T5. The apportioned buffer forward minimum is also identified as a “buffer apportioned forward minimum value” or “B_{AFM}”. This can be calculated as

$${B}_{AFM} = \frac{{B}_{FM} \times {S}_{S}}{{S}_{SFT}} .$$

For example, a buffer apportioned forward minimum value for task T1 is 0

$$( i . e . , \frac{0 \times 3.85}{121.40} ) .$$

When a buffer is applied to a task (described further below in greater detail), each downstream task is pushed back by an amount equal to the buffer applied to the upstream task. As a result, the available buffer for each downstream task can be less than or equal to the buffer that was originally available before the buffer was applied to any upstream task. Thus, for each task of tasks T1, T2, T3, T4, and T5, the dynamic task distribution system captures the effective buffer available value in a value that is identified as “buffer self available running value” or “B_{SR}”. In other words, a buffer self available initial value represents a buffer time that is available to a task, without taking into consideration any buffer time that has been distributed to any upstream tasks, whereas a buffer self available running value represents a buffer that is available to a task, after taking into consideration any buffer time that has been distributed to any upstream tasks. For example, a buffer self available running value for task T1 is 2, because no buffer time has been distributed to upstream tasks. However, a buffer self available running value for task T5 is 1, because a buffer time of 1 has been collectively distributed to upstream tasks T3 and T4. Further, for each task of tasks T1, T2, T3, T4, and T5, the dynamic task distribution system selects a minimum value between a buffer self available running value and a buffer apportioned forward minimum value, and distributes that value as a buffer time to each task. For each task of tasks T1, T2, T3, T4, and T5, the buffer time is applied at the end of the task (i.e., after the finish date-time of the task). Thus, a start date-time of a successor task is delayed by the buffer time.

The aforementioned scores and values that are calculated by the dynamic task distribution system for tasks T1, T2, T3, T4, and T5 are shown below in the following table:

| | | Score | Buffer | | Buffer | Buffer | | |
|---|---|---|---|---|---|---|---|---|
| | | Self | Self | Buffer | Apportioned | Self | | |
| | Score | Forward | Available | Forward | Forward | Available | | Next |
| Task | Self | Total | Initial | Minimum | Minimum | Running | Buffer | Task |
| Name | (Sₛ) | (S_{SFT}) | (B_{SI}) | (B_{FM}) | (B_{AFM}) | (B_{SR}) | Applied | Start |
| T1 | 3.85 | 121.40 | 2.00 | 0.00 | 0.00 | 2.00 | 0.00 | Nov. 28, 2013 |
| | | | | | | | | Start of Day |
| | | | | | | | | (“SOD”) |
| T2 | 100.00 | 117.55 | 0.00 | 1.00 | 0.85 | 0.00 | 0.00 | Nov. 29, 2013 |
| | | | | | | | | SOD |
| T3 | 6.98 | 17.55 | 2.00 | 1.00 | 0.80 | 2.00 | 0.80 | Dec. 4, 2013 + |
| | | | | | | | | 6.36 hrs |
| T4 | 9.09 | 10.57 | 1.00 | 2.00 | 1.72 | 0.20 | 0.20 | Dec. 9, 2013 |
| | | | | | | | | SOD |
| T5 | 1.48 | 1.48 | 2.00 | — | — | 1.00 | 1.00 | — |

FIG. 3 further illustrates a project plan 32 displayed by a dynamic task distribution system. Project plan 32 includes tasks T1, T2, T3, T4, and T5, which are displayed within a timeline. Task T1 has a finish-by date-time of Nov. 29, 2013 (end-of-day), indicated by arrow 321. Task T2 has a finish-by date-time of Nov. 28, 2013 (end-of-day), indicated by arrow 322. Task T3 has a finish-by date-time of Dec. 5, 2013 (end-of-day), indicated by arrow 323. Task T4 has a finish-by date-time of Dec. 6, 2013 (end-of-day), indicated by arrow 324. Task T5 has a finish-by date-time of Dec. 9, 2013 (end-of-day), indicated by arrow 325.

According to the embodiment, tasks T1, T2, T3, T4, and T5 are displayed in accordance with the buffer time previously distributed among the tasks by the dynamic task distribution system. More specifically, task T1 is displayed with a planned start date-time of Nov. 26, 2013 (start-of-day), with a planned finish date-time of Nov. 27, 2013 (end-of-day), and with a buffer time of 0. Task T2 is displayed with a planned start date-time of Nov. 28, 2013 (start-of-day), with a planned finish date-time of Nov. 28, 2013 (end-of-day), and with a buffer time of 0. Task T3 is displayed within a planned start date-time of Nov. 29, 2013 (start-of-day), with a planned finish date time of Dec. 3, 2013 (end-of-day), and with a buffer time of 0.8 days. Task 4 is displayed with a planned start date-time of Dec. 4, 2013 (+6.36 hours, or 0.8 of an 8-hour working day), with a planned finish date-time of Dec. 6, 2013 (+6.36 hours), and with a buffer time of 0.2 days. Task 5 is displayed with a planned start date-time of Dec. 9, 2013 (start-of-day), with a planned finish date-time of Dec. 9, 2013 (end-of-day), and with a buffer time of 1 day.

In certain embodiments, a task order of execution that is determined at the beginning of execution of a first task may not be the same as (and in fact may be expected to be different from) a task order of execution that is determined subsequently. Thus, in these embodiments, the dynamic task distribution system can frequently re-determine an order of task execution as the execution of the tasks progresses. Further, in some embodiments, while the examples of task ordering performed by a dynamic task distribution system have been described in the context of all tasks being assigned to a single resource, the dynamic task distribution system can determine an optimal order of execution of all project tasks assigned to multiple project resources. Additionally, in certain embodiments, the dynamic task distribution system can customize and enhance a scoring formula to factor in additional parameters, such as resource reliability of a resource that a task is assigned to, a research and development cost associated with a task, etc. Further, in some embodiment, while the examples of buffer time distribution have been described in the context of distributing all buffer time at the end of a task, the dynamic task distribution system can distribute the buffer time among both ends of the task (e.g., 25% of the buffer time before a start of the task and 75% of the buffer time after a finish of the task).

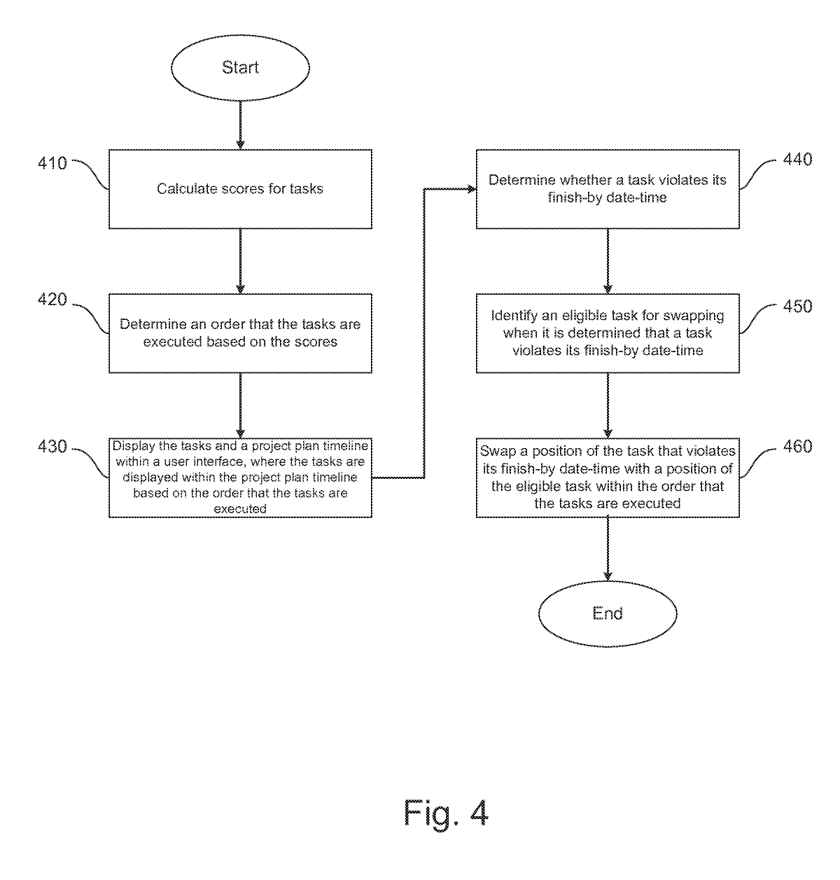

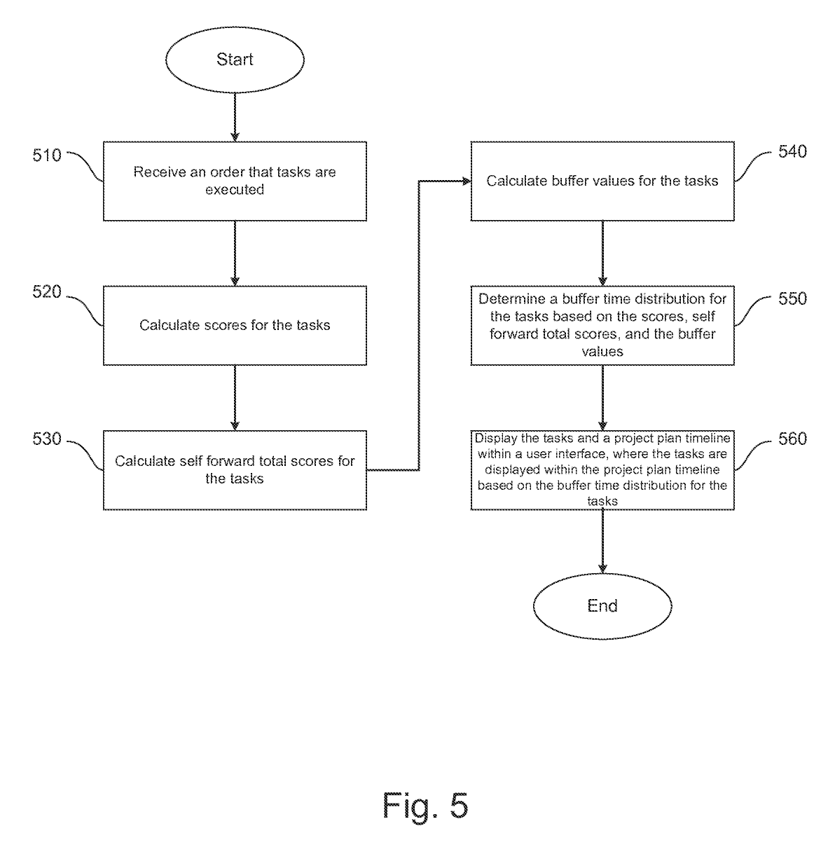

FIG. 4 illustrates a flow diagram of the functionality of a dynamic task distribution module (such as dynamic task distribution module 16 of FIG. 1), according to an embodiment of the invention. In one embodiment, the functionality of the flow diagram of FIG. 4, as well as the functionality of the flow diagram of FIG. 5, are each implemented by software stored in a memory or some other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In certain embodiments, some of the functionality can be omitted.

The flow begins, and proceeds to 410. At 410, a plurality of scores is calculated for a plurality of tasks. Each score can be calculated based on: a finish-by date-time for each task; a planned finish date-time for each task; a planned effort for each task; and a base priority for each task. The flow then proceeds to 420.

At 420, an order that the plurality of tasks are executed is determined based on the plurality of scores. The flow then proceeds to 430.

At 430, the plurality of tasks and a project plan timeline are displayed within a user interface. The plurality of tasks can be displayed within the project plan timeline based on the order that the plurality of tasks are executed. The flow then proceeds to 440.

At 440, it is determined whether a task violates its finish-by date-time. The flow then proceeds to 450.

At 450, an eligible task for swapping is identified when it is determined that a task violates its finish-by date-time. In certain embodiments, the eligible task can be required to satisfy a pre-defined criteria. In some of these embodiments, the eligible task can be required to meet the following pre-defined criteria: (a) by swapping a position of the task that violates its finish-by date-time with a position of the eligible task within the order that the plurality of tasks are executed, the task does not violate its finish-by date-time; and (b) the eligible task has the lowest score of one or more tasks that satisfy (a). The flow then proceeds to 460.

At 460, a position of the task that violates its finish-by date-time is swapped with a position of the eligible task within the order that the plurality of tasks are executed. The flow then ends.

FIG. 5 illustrates a flow diagram of the functionality of a dynamic task distribution module (such as dynamic task distribution module 16 of FIG. 1), according to another embodiment of the invention. The flow begins and proceeds to 510. At 510, an order that a plurality of tasks are executed is received. In certain embodiments, the order that the plurality of tasks are executed is determined according to the flow diagram illustrated in FIG. 4. In certain other embodiments, the order of execution may be derived from attributes based on the exact nature of these tasks. The flow then proceeds to 520.

At 520, a plurality of scores is calculated for the plurality of tasks. Each score can be calculated based on: a finish-by date-time for each task; a planned finish date-time for each task; a planned effort for each task; and a base priority for each task. The flow then proceeds to 530.

At 530, a plurality of self forward total scores is calculated for the plurality of tasks. Each self forward total score can be calculated based on: a score for each task; and one or more scores for one or more tasks that are downstream from each task. The flow then proceeds to 540.

At 540, a plurality of buffer values is calculated for the plurality of tasks. The plurality of buffer values can include: a buffer self available initial value; a buffer forward minimum value, a buffer apportioned forward minimum value, and a buffer self available running value. Each buffer self available initial value can be calculated based on a difference of a planned finish date-time and a planned start date-time for each task. Each buffer forward minimum value can be calculated based on a minimum value of one or more buffer self available initial values for one or more tasks that are downstream from each task. Each buffer apportioned forward minimum value can be calculated based on a score, a self forward total score, and buffer forward minimum value for each task. Each buffer self available running value can be calculated based on a buffer self available initial value for each tasks and one or more buffer times that have been distributed to one or more tasks that are upstream from each task. The flow then proceeds to 550.

At 550, a buffer time distribution for the plurality of tasks is determined based on the plurality of scores, the plurality of self forward total scores, and the plurality of buffer values. The flow then proceeds to 560.

At 560, the plurality of tasks and a project plan timeline are displayed within a user interface. The plurality of tasks can be displayed within the project plan timeline based on the order that the plurality of tasks are executed and the buffer time distribution for the plurality of tasks. The flow then ends.

Thus, a dynamic task distribution system is provided that can dynamically determine an order of task execution and a buffer time distribution for a set of tasks. The dynamic task distribution system can be coupled with and existing task sequencing systems or task dispersing systems. Thus, the dynamic task distribution system can assist with existing task scheduling engines to optimally distribute available buffer time among the tasks to increase changes of recovery in case of task delays, or other types of failure. By calculating a score for each task based on one or more parameters, and by determining the order of task execution and buffer time distribution based on the calculated scores, the dynamic task distribution system can provide a more optimal and customizable distribution of the tasks. Further, by distributing buffer time among the tasks, the dynamic task distribution system can include all potential buffer time within a schedule of tasks, potentially eliminating a need for repetitive scheduling of tasks in response to a task delay, or other type of failure.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to dynamically distribute tasks, the dynamic distributing comprising:
calculating a plurality of scores for a plurality of tasks, wherein each score is calculated based on a finish-by date-time for each task, a planned finish date-time for each task, a planned effort for each task, and a base priority for each task;
determining an order that the plurality of tasks are executed based on the plurality of scores; and
displaying the plurality of tasks and a project plan timeline within a user interface;
wherein the plurality of tasks are displayed within the project plan timeline based on the order that the plurality of tasks are executed.

2. The computer-readable medium of claim 1, the dynamic distributing further comprising determining whether a task violates its finish-by date-time.

3. The computer-readable medium of claim 2, the dynamic distributing further comprising identifying an eligible task for swapping when it is determined that a task violates its finish-by date-time.

4. The computer-readable medium of claim 3, wherein: (a) by swapping a position of the task that violates its finish-by date-time with a position of the eligible task within the order that the plurality of tasks are executed, the task does not violate its finish-by date-time; and (b) the eligible task has the lowest score of one or more tasks that satisfy (a).

5. The computer-readable medium of claim 3, the dynamic distributing further comprising swapping a position of the task that violates its finish-by date-time with a position of the eligible task within the order that the plurality of tasks are executed.

6. The computer-readable medium of claim 1, the dynamic distributing further comprising:
determining a buffer time distribution for the plurality of tasks based on the plurality of scores;
wherein the plurality of tasks are displayed within the project plan timeline based on the buffer time distribution for the plurality of tasks.

7. The computer-readable medium of claim 6, the dynamic distributing further comprising calculating a plurality of self forward total scores for the tasks.

8. The computer-readable medium of claim 7, the dynamic distributing further comprising calculating a plurality of buffer values for the tasks.

9. The computer-readable medium of claim 8, wherein the plurality of buffer values comprises: a buffer self available initial value; a buffer forward minimum value, a buffer apportioned forward minimum value, and a buffer self available running value.

10. The computer-readable medium of claim 8, wherein the determining the buffer time distribution for the plurality of tasks is further based on the plurality of self forward total scores and the plurality of buffer values.

11. A computer-implemented method for dynamically distributing tasks, the computer-implemented method comprising:
calculating a plurality of scores for a plurality of tasks, wherein each score is calculated based on a finish-by date-time for each task, a planned finish date-time for each task, a planned effort for each task, and a base priority for each task;
determining an order that the plurality of tasks are executed based on the plurality of scores; and
displaying the plurality of tasks and a project plan timeline within a user interface;
wherein the plurality of tasks are displayed within the project plan timeline based on the order that the plurality of tasks are executed.

12. The computer-implemented method of claim 11, further comprising:
determining whether a task violates its finish-by date-time; and
identifying an eligible task for swapping when it is determined that a task violates its finish-by date-time.

13. The computer-implemented method of claim 12, further comprising swapping a position of the task that violates its finish-by date-time with a position of the eligible task within the order that the plurality of tasks are executed.

14. The computer-implemented method of claim 11, further comprising:
determining a buffer time distribution for the plurality of tasks based on the plurality of scores;
wherein the plurality of tasks are displayed within the project plan timeline based on the buffer time distribution for the plurality of tasks.

15. The computer-implemented method of claim 14, further comprising:
calculating a plurality of self forward total scores for the tasks; and
calculating a plurality of buffer values for the tasks;
wherein the determining the buffer time distribution for the plurality of tasks is further based on the plurality of self forward total scores and the plurality of buffer values.

16. A system for dynamically distributing tasks, the system comprising:
a score calculation module configured to calculate a plurality of scores for a plurality of tasks, wherein each score is calculated based on a finish-by date-time for each task, a planned finish date-time for each task, a planned effort for each task, and a base priority for each task;
an order determination module configured to determine an order that the plurality of tasks are executed based on the plurality of scores; and
a task display module configured to display the plurality of tasks and a project plan timeline within a user interface; wherein the plurality of tasks are displayed within the project plan timeline based on the order that the plurality of tasks are executed.

17. The system of claim 16, further comprising:
a task violation determination module configured to determine whether a task violates its finish-by date-time; and
an eligible task identification module configured to identify an eligible task for swapping when it is determined that a task violates its finish-by date-time.

18. The system of claim 16, further comprising a task position module configured to swap a position of the task that violates its finish-by date-time with a position of the eligible task within the order that the plurality of tasks are executed.

19. The system of claim 16, further comprising:
a buffer time distribution module configured to determine a buffer time distribution for the plurality of tasks based on the plurality of scores;
wherein the task display module is further configured to display the plurality of tasks within the project plan timeline based on the buffer time distribution for the plurality of tasks.

20. The system of claim 19, further comprising:
a self forward total score module configured to calculate a plurality of self forward total scores for the tasks; and
a buffer value module configured to calculate a plurality of buffer values for the tasks;
wherein the buffer time distribution module is further configured to determine the buffer time distribution for the plurality of tasks based on the plurality of self forward total scores and the plurality of buffer values.
